(19) United States
(12) Patent Application Publication
(10) Pub. No.: US 2010/0326084 A1
(43) Pub. Date: Dec. 30, 2010

(54) Methods of oxy-combustion power generation using low heating value fuel

(76) Inventors: Roger E. Anderson, Gold River, CA (US); Fermin Viteri, Sacramento, CA (US); Lawrence C. Hoffman, Citrus Heighs, CA (US); Cheryl Lynn Hoffman, Citrus Heights, CA (US); Keith L. Pronske, Wilton, CA (US)

Correspondence Address: BRADLEY P. HEISLER;HEISLER & ASSOCIATES, 3017 DOUGLAS BOULEVARD, SUTIE 300, ROSEVILLE, CA, 95661, US

(21) Appl. No.: 12/660,779

(22) Filed: Mar. 4, 2010

Related U.S. Application Data
(60) Provisional application No. 61/209,324, filed on Mar. 4, 2009.

(51) Int. Cl. F01K 23/10; F02C 3/04; F02C 6/00; F02C 3/30

(52) U.S. Cl. 60/775; 60/772; 60/783; 60/805; 60/750; 60/39.182

(57) ABSTRACT

An oxy-combustor is provided to combust oxygen with gaseous low heating value fuel. A compressor upstream of the combustor compresses the fuel. The combustor produces a drive gas including steam and carbon dioxide as well as other non-condensable gases in many cases, which pass through a turbine to output power. The drive gas can be recirculated to the combustor, either through the compressor, the oxygen inlet or directly to the combustor. Recirculation can occur before or after a condenser for separation of a portion of the water from the carbon dioxide. Excess carbon dioxide and steam is collected from the system. The turbine, combustor and compressor can be derived from an existing gas turbine with fuel and air/oxidizer lines swapped.

### CROSS-REFERENCE TO RELATED APPLICATIONS

This application claims benefit under Title 35, United States Code §119(e) of U.S. Provisional Application No. 61/209,324 filed on Mar. 4, 2009.

### FIELD OF THE INVENTION

The following invention relates to fuel combustion power generation systems, and especially oxy-combustion power generation systems which minimize atmospheric pollutant generation and release by combustion with oxygen, rather than air. More particularly, this invention relates to power generation systems which are configured to combust fuels having a low heating value than natural gas and which potentially contain a large proportion of pollutants therein, in low or non-polluting ways and to generate power.

### BACKGROUND OF THE INVENTION

For over a century baseline electric power has been largely supplied through power plants combusting a hydrocarbon fuel to energize a working fluid that has been passed through a turbine where the working fluid is expanded and the turbine drives an electric generator. Such power plants have also provided useful energy in the form of heat for cogeneration applications.

In the late 19th century and the first half of the 20th century such power plants typically utilized a Rankine cycle where water was externally heated into steam in a boiler. This steam was then run through a steam turbine which would drive a generator and expand the steam into a lower energy condensing gas. This condensing steam would then be routed to a condenser where it would condense back into a liquid and then be recycled back to the boiler. Many such Rankine cycle power plants are still in operation today and can achieve thermal efficiencies of up to about forty percent. A primary limiting factor on efficiency for such Rankine cycle power plants is the turbine inlet temperature for such steam turbines and the ability of boilers to heat the steam to higher temperatures for efficiency improvement.

In the latter half of the 20th century gas turbines were developed which utilize the Brayton cycle. Such gas turbines employ direct heating where the hydrocarbon fuel is combusted in air and the exhaust from this combustion reaction (including oxygen depleted air, as well as steam and carbon dioxide) is routed through a gas turbine to drive a generator. The exhaust gases in such gas turbine power plants are typically directly exhausted to the environment in an “open” Brayton cycle. Often for maximum efficiency, the discharged gases have sufficient heat that they can be utilized to either raise steam for cogeneration or raise steam for additional power production within a Rankine cycle, or both. Modern combined cycle (Brayton and Rankine) power plants have achieved thermal efficiencies approaching sixty percent. Thus, for a given amount of fuel, such gas turbine based combined cycle power plants can achieve approximately fifty percent more power than Rankine cycle counterparts. The primary reason for this enhanced thermal efficiency is the high turbine inlet temperatures which have been achieved through careful design and use of high temperature materials to withstand the high turbine inlet temperatures.

In the 21st century new challenges are faced to meet the power needs of modern society while being sensitive to environmental concerns. Issues not yet satisfactorily solved with prior art gas turbine and combined cycle power plants include avoidance of emissions of greenhouse gases, especially CO₂, and other pollutants, as well as the flexibility to employ hydrocarbon fuels that are readily available and yet not suitable for combustion within gas turbine power plants.

One technique for addressing the carbon dioxide emissions problem is to utilize “oxyfuel combustion” rather than combustion of the hydrocarbon fuel with air. By combusting with oxygen or oxygen-rich gas mixtures, carbon dioxide generated by the combustion process is provided in a more pure form or with constituents from which the carbon dioxide can be readily separated, for effective sequestration of the carbon dioxide away from the surrounding atmosphere. Examples of such oxyfuel combustion power generation systems include U.S. Pat. Nos. 5,680,764, 5,709,077 and 6,206,684, incorporated herein by reference in their entirety.

Furthermore, some hydrocarbon fuels are available which have relatively low heating values. Such low heating value fuels include blast furnace gas (made up of for instance 40% carbon dioxide, 33% nitrogen, 26% carbon monoxide and less than 1% hydrogen), waste refinery gas, low quality natural gas, carbon monoxide and any other hydrocarbon fuels or fuels akin to hydrocarbon fuels which generally have a heating value less than that of natural gas and which are gaseous at standard temperature and pressure or can be so converted (i.e. coal and solid fuel gasification).

Such low heating value gases cannot readily be utilized in gas turbines because gas turbines have been optimized for combustion with natural gas or other fuels with a heating value similar to or higher than that of natural gas. Such low heating value fuels can be combusted in boilers configured for that purpose to raise steam for use in a Rankine cycle power plant. However, such steam power plants require a customized boiler, and suffer from the generally lower efficiencies associated with use of such a low heating value fuel. Also, the pollutants from the exhaust stack of such plants are combined with excess air and are difficult to separate.

Furthermore, the carbon dioxide generated by combustion of such low heating value gases ends up being exhausted from the boiler after having been mixed with the oxygen depleted air used for combustion, so that the carbon dioxide generated by combustion of the low heating value fuel is not readily kept away from the atmosphere. Accordingly, a need exists for a way to use low heating value gas for power generation without suffering from the disadvantages of requiring utilization of specialized equipment, limitations of steam turbine efficiencies, and with effective sequestration of CO₂ and other pollutants generated by combustion of such low heating value gas.

### SUMMARY OF THE INVENTION

With this invention a power generation system is provided which avoids utilization of significant new customized equipment in a power plant while simultaneously providing for use of low heating value fuels and also configuring the system to efficiently sequester carbon dioxide generated therein more readily. Two concepts are disclosed for such a low (or zero) emissions power generation system utilizing low heating value fuel.

The first concept is to use a conventional type of gas turbine wherein the “air” and fuel circuits are reversed (see FIGS. 1 and 2). A low-pressure, low heating value fuel (such as blast furnace gas, waste refinery gas, low-quality natural gas, etc.) is fed to the “air” inlet section where it is compressed and delivered to the combustor(s). The compressed low heating value fuel is then burned in the combustor(s) with an O₂-rich oxidizer, entering via the original “fuel” circuit. If the heating value of the fuel is too low, it can be blended with a higher heating value fuel (such as natural gas, coke-oven gas, refinery gases, H₂, etc.) to achieve the desired heating value or Wobbe Index. If the heating value is somewhat too high it can be blended with recycle exhaust gas from the turbine exhaust, an inert gas, or a very low heating value gas. Such gases could be at least partially recirculated carbon dioxide or steam downstream from the gas turbine discharge.

Similarly or alternatively, the “O₂-rich oxidizer” used to burn the low heating value fuel can be adjusted upward in O₂ content by use of higher quality O₂ or enrichment with nearly pure O₂ or can be adjusted downward by dilution with air, recycle exhaust gas from the turbine exhaust or an inert gas. The combustors can be modified to operate stably on the new mixture. The compressor and power turbine sections would be used as-is or with minor modification because the low heating value fuel and combustion products would have molecular weights and ratios of specific heats (Cᵥ/Cₚ) relatively similar to air/natural gas systems for which the gas turbine equipment is designed.

A second concept for utilizing low heating value fuel to produce power with low (or zero) emissions, is depicted in FIG. 3 and the table of FIG. 4. In this embodiment, a gas generator is provided as an oxyfuel combustor for combustion of the low heating value fuel with an oxygen rich oxidizer and then driving appropriate turbines or other expanders with the working fluid drive gas produced within the gas generator. Such gas generators are disclosed in U.S. Pat. Nos. 5,680,764, 5,709,077 and 6,206,684 incorporated herein by reference.

One unique characteristic of the oxy-combustor is the fact that it involves the injection of relatively large quantities of water and/or cool diluent gas directly into the high temperature combustion zone. Temperatures in this zone are sufficiently high (3,000° F. to 6000° F.) to convert virtually all of the fuel into H₂O and CO₂, provided there is sufficient oxygen to complete the combustion process. Generally, 1% excess oxygen is used to insure complete combustion takes place.

Due to this feature, the combustor readily permits the injection of low Btu waste fuels, with large quantities of CO₂ and N₂, in addition to CO and H₂, directly into the combustion chamber. Such fuels include, but are not limited to, blast furnace gases (BFG), biomass fuels, sour gas (methane+CO₂), and syngases derived from coal. A preferred embodiment is the use of blast furnace gas (BFG) as the fuel (see FIG. 3). BFG is a byproduct of steel production process and contains large quantities of CO₂ and N₂, which are non-condensable gases with no heating value.

### OBJECTS OF THE INVENTION

Accordingly, a primary object of the present invention is to provide a system that uses existing conventional gas turbines which minimize development, capital and operation and maintenance costs.

Another object of the present invention is to provide the ability to utilize low heating value, low-cost, low-pressure fuels for power generation such as waste gases from refineries, low quality natural gas, digester gases, land-fill gases, blast furnace gases (BFG) etc.

Another object of the present invention is to produce exhaust gases relatively rich in carbon dioxide which are beneficial in reducing the cost of carbon capture and storage when using low heating value fuels.

Another object of the present invention is to provide a power plant which can combust a low Btu fuel without requiring a specially designed compressor/gas generator or gas turbine therefore.

Another object of the present invention is to provide a power generation system which can combust low heating value fuels having constituents which result in non-condensable product gases, and which beneficially utilize the non-condensable gases as a diluent for the combustor.

Another object of the present invention is to provide a power plant fueled by combustion of low heating fuels with oxygen to generate power with little or not emissions.

Another object of the present invention is to provide a power generation system which utilizes a low heating value fuel which generates large amounts of carbon dioxide, but which readily separates the carbon dioxide into a sequesterable flow, by separation of water vapor and also nitrogen or other non-condensable gases.

Another object of the present invention is to provide a new use for an existing gas turbine by swapping air and fuel lines with oxidizer and fuel lines and an oxy-combustion system utilizing a low heating fuel fed into the compressor of the gas turbine.

Another object of the present invention is to provide a method for beneficial use of a waste gas discharged from an industrial process while keeping the waste gas from contaminating the environment.

Other further objects of the present invention will become apparent from a careful reading of the included drawing figures, the claims and detailed description of the invention.

### BRIEF DESCRIPTION OF THE DRAWINGS

FIG. 1 is a schematic of a reverse circuit gas turbine power generation system which utilizes an existing gas turbine but with fuel fed into the compressor rather than air and with oxygen fed into fuel lines of the combustor rather than fuel, and with appropriate recirculation lines to recirculate products of combustion to at least partially close the system.

FIG. 2 is a schematic of a detailed specific embodiment of the reverse circuit gas turbine power generation system of FIG. 1.

FIG. 3 is a schematic of an alternative embodiment power generation system utilizing a gaseous low heating value fuel with non-condensable gas producing constituents, including nitrogen in this particular example.

FIG. 4 is a table outlining performance characteristics for power generation systems such as those shown in FIGS. 2 and 3 with various different numbers of stages of CO₂ separation and utilizing blast furnace gas (BFG) as the fuel.

### DESCRIPTION OF THE PREFERRED EMBODIMENT

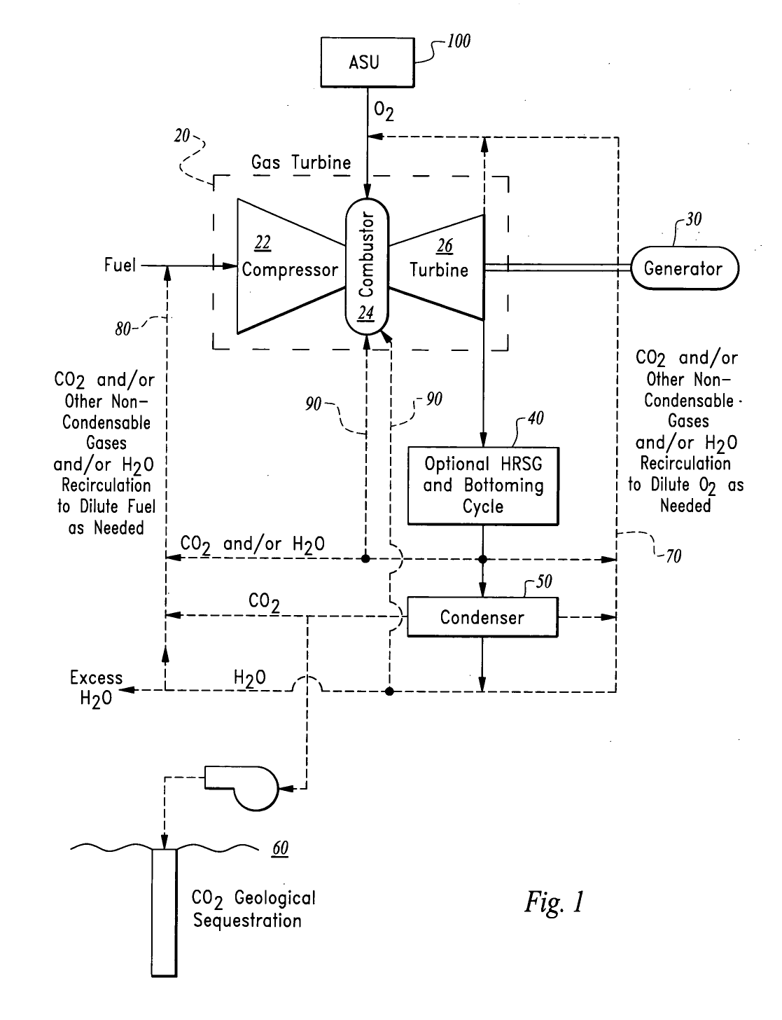

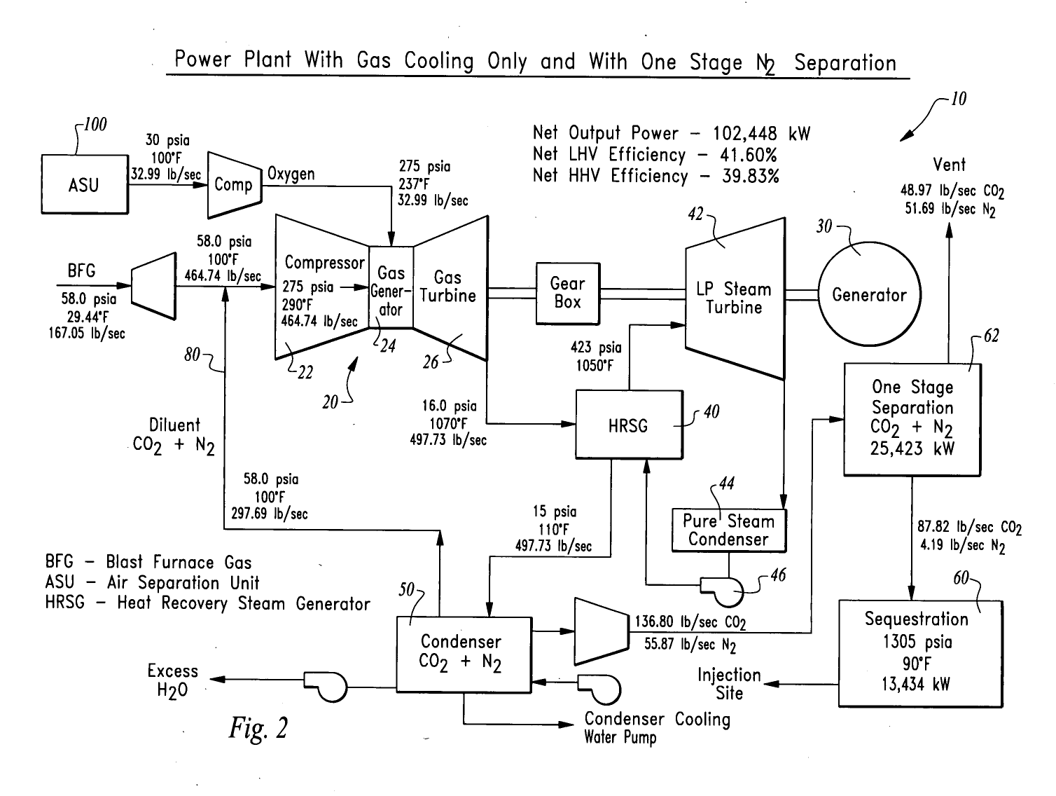

Referring to the drawings, wherein like reference numerals represent like parts throughout the various drawing figures, reference numeral 10 is directed to a power generation system with a reverse circuit gas turbine 20 (FIGS. 1 and 2) centrally featured therein. In this example system a standard gas turbine 20 can be utilized to combust a low heating value fuel, such as blast furnace gas (BFG). The fuel and air circuits of the gas turbine 20 are reversed so that the low heating value fuel is introduced into a compressor 22 of the gas turbine 20 while the oxygen is directed into a combustor 24 of the gas turbine 20 through the “fuel inlet.” In a second embodiment, the low heating value fuel is combusted within an oxy-combustion gas generator 120 power generation system 110 featuring recirculation of non-condensable gases such as those which are often produced by combustion of a low heating value fuel that includes non-condensable gas producing constituents therein, such as nitrogen, as is the case with BFG. In this power generation system 110, the gas generator 120 is utilized, feeding drive gas to appropriate turbines 130 and with recirculation of portions of the drive gas back to the gas generator 120.

In the exemplary system 10 shown in FIG. 2, two streams are injected into a modified gas turbine 20: (1) a low heating value fuel (e.g. blast furnace gas (BEG)) is introduced into the normal air inlet of the compressor 22 and (2) an oxygen-rich oxidizer is introduced into the normal fuel inlet of the combustor 24. The low heating value fuel consists primarily of carbon and/or hydrogen containing gases and inerts, such as nitrogen, carbon dioxide (CO₂), carbon monoxide (CO) or water vapor, but preferably does not contain significant quantities of impurities that would present corrosion problems in the combustor 24 or downstream power generation equipment. The oxygen-rich oxidizer is primarily O₂, typically supplied from an air separation unit (ASU) 100, and could contain inerts such as nitrogen, carbon dioxide and water vapor.

The quantities of materials (O₂, fuels and inerts) shown by the dashed lines of FIG. 1 are selected and adjusted to produce the volumetric inlet ratios most consistent with the normal design requirements of an existing gas turbine 20 design, and to produce combustion temperatures also most consistent with the normal design requirements of the gas turbine 20.

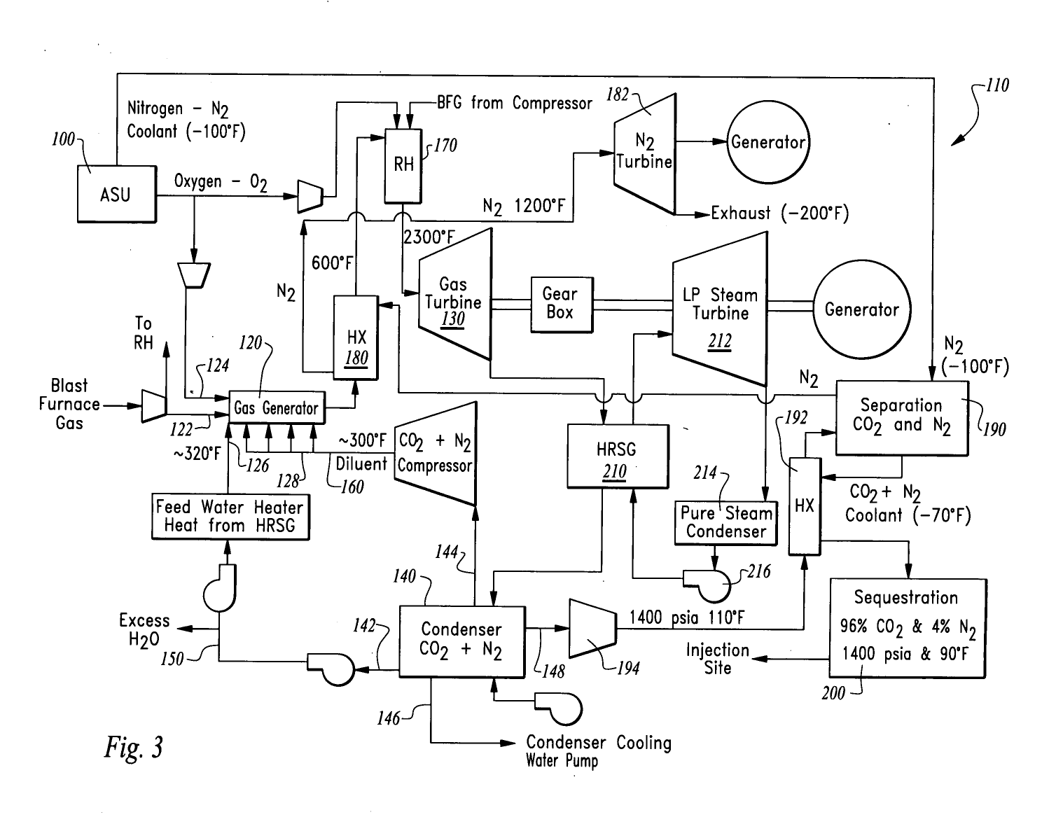

The ASU 100 could utilize pressure swing adsorption or cryogenic liquefaction, or other air separation technologies for generation of oxygen. It is also conceivable that oxygen could be supplied by pipeline, anchor truck delivery, or through some other process which collects oxygen other than by separation from air. In the case of an ASU 100 based on liquefaction, compressor loads of the ASU 100 can at least partially be provided directly by shaft power from the gas turbine 20 or indirectly on site with power generated from the gas turbine 20. Cool nitrogen emitted from the ASU can be beneficially utilized, such as to enhance the efficiency or minimize the size of the condenser 50 that would typically be provided downstream from the turbine 26 to condense water from carbon dioxide in the exhaust. Residual energy in the nitrogen can be routed to an auxiliary turbine (e.g. turbine 182 of FIG. 3) for additional power generation.

Because the CO₂ is generally inert, it can beneficially be added either to the oxygen to minimize combustion temperature or to the fuel to minimize combustion temperature, or both. This carbon dioxide can be added in a substantially pure form or combined with nitrogen, argon or water/steam or other constituents within the combustion products or otherwise provided. Because combustion of the low heating value fuel results in the generation of significant amounts of carbon dioxide, the carbon dioxide would not need to be separately supplied but would merely be utilized in a recycled fashion within the power generation system 10. In fact, excess carbon dioxide would be formed which would typically be separated within the condenser 50 downstream of the turbine 26.

Excess carbon dioxide not needed for moderation of temperature or other aspects of the combustion reaction within the gas turbine 20 could be pressurized and sequestered 60 away from the atmosphere, such as by utilization in enhanced oil recovery or enhanced natural gas recovery operations, or merely by transportation into a subterranean formation for geological storage away from the atmosphere either on land or at sea. In addition to moderation of temperature, the performance of the compressor 22 of the gas turbine 20 would preferably be optimized by blending the low heating value gas with sufficient amounts of either carbon dioxide or higher heating value fuels (e.g. natural gas) both to match temperature requirements for the gas turbine 20 and also to match density and other gas characteristics so that the fuel gas compressed by the compressor 22 of the gas turbine 20 has characteristics as close to air as possible to maintain the gas turbine 20 operating at or near its design. One particular gas turbine suitable for modification according to this invention is known as a SGT-900 gas turbine provided by Siemens-Westinghouse Power Corp. of Orlando, Fla.

The blending of the oxygen rich oxidizer and the low heating value fuel could occur in a variety of ways. In one form of the invention the low heating value fuel would be carefully analyzed and the oxygen rich oxidizer would be selected to maximize the matching of characteristics of the oxygen rich oxidizer and the fuel with characteristics of fuel and air for the gas turbine 20 according to its original design. In this way, the gas turbine 20 can be an existing piece of equipment rather than a newly designed machine. Except however, that the fuel and oxidizer/air lines would be reversed with this invention from the routing of fuel and air in the original gas turbine 20. Once the oxidizer composition has been selected, the power plant 10 would be put into operation and would operate in accordance with the planned design for the power plant 10.

In another form of the first concept of this invention, particularly when different low heating value fuels might be utilized at different times, blending equipment could be provided that is coupled with appropriate valves and control systems for active control of the heating value of the fuel and the percentage of oxygen within the oxygen rich oxidizer. Performance characteristics of the gas turbine 20 including temperature and pressure, as well as velocities of the gases would be monitored at appropriate locations, such as at the inlet of the compressor 22, the outlet of the compressor 22, the inlet of the turbine 26 and the outlet of the turbine 26 for optimum performance. Information sensed in the operation of the gas turbine 20 would be fed into a control system to adjust valves at the blending stations so that the gas turbine 20 would maintain optimum performance or performance within set limiting parameters. Other factors that the control system could factor in could include the availability of different fuels so that constituent fuels would not “run out” during operation of the power plant 10, and/or to optimize for the price of the fuels to minimize the cost associated with generation of a unit of power by the power plant 10, or to optimize power output, or to optimize emissions.

Other potential modifications include utilizing multiple gas turbines 20 in parallel fed by common supplies of fuel and oxidizer, or operation of multiple gas turbines 20 in series, or in conjunction with steam turbines (e.g. turbine 42 of FIG. 3) potentially operating at different temperatures and pressures to meet the design goals presented in each particular case. FIG. 2 illustrates such a system with both a gas turbine 20 and a steam turbine 42 in a combined cycle arrangement. This exemplary design has been optimized for blast furnace gas (BFG) utilization.

Combustion modification could be performed to address issues such as materials compatibility. Ideally, the gas turbine 20 utilized in the power plant 10 would be an existing gas turbine 20. However, gas turbines could be custom manufactured for utilization according to this invention which might enjoy a simplified design process by utilizing known prior art gas turbine design details where possible and limiting design modification to those necessary or beneficial when reversing the fuel and oxidizer/air circuits for the gas turbine.

More specifically, and with particular reference to FIG. 2, details of a particular embodiment of the power generation system 10 of this invention are described. A central component of the system 10 is the gas turbine 20, preferably modified as little as possible from an existing gas turbine design, except that fuel and oxidizer lines have been swapped. In particular, the gas turbine includes a compressor 22 adjacent a combustor 24 and upstream of a turbine 26. Blast furnace gas (BFG) or other low heating value fuel is introduced into an inlet of the compressor 22. The BFG or other fuel might require a precompressor to provide the BFG at optimal conditions for introduction into the compressor 22. Diluent gas is also preferably supplied along with the BFG at the inlet of the compressor 22, supplied from diluent recirculation path 80.

The combustor 24 of the gas turbine 20 is fed with an oxidizer that is preferably substantially pure oxygen, but at a minimum is an oxidizer having a greater amount of oxygen than an amount present in the air (i.e. about twenty percent). In the illustrated embodiment the oxygen is supplied from an air separation unit (ASU) 100. The oxygen is compressed to a pressure required for introduction into the combustor 20. The oxygen is fed into the combustor 24 through “fuel inlet lines” that would typically be originally designed for delivery of natural gas or other design fuel into the gas turbine 20. If required, gas handling fittings can be modified to utilize appropriate materials for the handling of oxygen. The combustor 24 would include some form of igniter which would initiate the combustion process between the oxygen and the BFG or other low heating value fuel. A drive gas of primarily steam and carbon dioxide would result, which might also include inert/non-condensable gases such as nitrogen therein, especially if such gases are initially present within the BFG or other fuel. This drive gas is then routed through the turbine 26. The turbine drives a generator 30 as is known in the art or otherwise outputs power.

The drive gas is discharged from the turbine 26 and at least a portion of this drive gas is recirculated back to the gas turbine 20, either through the fuel line along the fuel recirculation path 80 or back to the oxygen inlet of the combustor 24 along the oxidizer recirculation path 70 (FIG. 1). Most preferably, a condenser 50 is located along this recirculation path for the drive gases. The condenser 50 cools the drive gas sufficiently that at least water constituents within the drive gas at least partially condense and are discharged from the condenser 50. This water discharge can be routed back to the gas turbine 20, either along the fuel recirculation path 80 or the oxidizer recirculation path 70 (FIG. 1). Most preferably for use in the gas turbine 20, the water from the condenser would initially be pumped to require inlet pressures and heated, such as through a heat exchanger exchanging heat from some high temperature portion of the system so that the water could enter the gas turbine 20 as steam in a gaseous phase. Excess water would be separately discharged from the condenser 50 and be substantially pure water which could be separately utilized.

Non-condensable gases within the condenser 50 would include carbon dioxide, and other non-condensable gases, such as nitrogen when the fuel is BFG. Non-condensable gases would also include some amount of water vapor typically and potentially other non-condensable gases. Preferably, these non-condensable gases are discharged from the condenser in two different ways. First, some of the non-condensable gases can be routed along the fuel recirculation path 80 or the oxidizer recirculation path 70 (FIG. 1) to act as a diluent to either decrease the heating value of the fuel entering the compressor 22 or decrease the mixture ratio of oxygen to fuel by inclusion of the non-condensable gases with the oxygen inlet to the combustor 24 of the gas turbine 20.

Remaining non-condensable gases are discharged from this primary Brayton cycle circuit of the power generation system 10. In a preferred embodiment, such excess non-condensable gases are initially compressed and then fed to a separator. Such a separator 62 is particularly desirable where a large amount of non-CO₂ non-condensable gases are provided, such as when large amounts of nitrogen are contained within the fuel (as is the case typically with BFG). Rather than sequester nitrogen, which has no negative environmental impact should it be discharged to the atmosphere, it is beneficial to remove as much of the nitrogen (and other non-CO₂ benign non-condensable gases) from the carbon dioxide as can be conveniently removed. Other non-condensable gases other than carbon dioxide might also beneficially be removed (e.g. argon).

This separator 62 is most preferably of a cryogenic type which pressurizes, cools and expands the non-condensable gases sufficient to cause the carbon dioxide to condense. The carbon dioxide can then be separated for sequestration 60 or other industrial use, away from the atmosphere. Remaining nitrogen and other non-pollutant non-condensable gases (e.g. argon) could then be vented to the atmosphere. As another alternative, these remaining non-condensable gases could be collected for separate industrial use or sale to others. In one form of the invention, cooling within the separator 62 can be provided from cool nitrogen being discharged from the ASU 100 (see FIG. 3).

In this power generation system 10 embodiment of FIG. 2 a heat recovery steam generator (HRSG) 40 is also interposed within the primary Brayton cycle circuit between the turbine 26 of the gas turbine 20 and the condenser 50. The HRSG 40 transfers heat away from the drive gas discharged from the turbine 26 to a separate Rankine bottoming cycle. This bottoming cycle in a simplest form of the invention could merely act to raise steam for use in various different processes, such that the overall plant 10 would be configured as a cogeneration plant. In the embodiment depicted in FIG. 2, the HRSG 40 boils steam in a separate circuit that is then routed to a low pressure steam turbine 42 for additional power output from the system 10. The discharge from the turbine 42 is routed to a steam condenser 44. A pump 46 then pumps the condensed water back to high pressure for rerouting to the HRSG 40 so that the water working fluid can continue operating in the basic Rankine cycle arrangement depicted in FIG. 2.

The power plant embodiment of FIG. 2 includes specific parameters including pressure, temperature and flow rates for one typical embodiment, as well as representative output net power and thermal efficiencies for the power generation system. As can be seen, relatively power output (greater than 100 MW) are provided and high efficiencies are achieved, even though significant parasitic power requirements are involved to power the ASU 100 and the sequestration 60, as well as the nitrogen separation.

With particular reference to FIG. 3, details of a second embodiment power plant 110 utilizing low heating value fuel is described. In the system 110, shown in FIG. 3, three separate streams are injected in an oxy-combustor gas generator 120: i.e., (1) oxygen (or O₂ rich oxidizer), (2) a high or low Btu fuel gas and (3) water and/or cool diluent gas. The fuels may contain any component of fuel value provided it consists of C, H and O. The fuel gas represents the thermal input to the cycle and may include high Btu fuels, such as natural gas (NG), or low Btu fuels such as blast furnace gas (BFG), landfill gas, biomass gas or synthesis gases derived from coal. The output of the gas generator 120 is a high-pressure (>100 psia), high-temperature (>700° F.) gas comprising of steam (H₂O), CO₂ and non-condensable gases such as N₂ with traces of argon and excess O₂, that is used to drive one or more turbines 130.

In closed loop cycles, the exhaust from the gas turbine 130 enters an optional heat recovery steam generator (HRSG) 210 where the exhaust heat is transferred to raise pure steam that drives a steam turbine 212. The exhaust gas from the gas turbine 130 then enters a condenser 140 where water is condensed and removed. The condensate minus the excess water is recycled back to the HRSG along line 142 where heat is optionally added, then returned along water recirculation line 140 to the gas generator 120 for cooling the injector face and quenching the high temperature gases.

The CO₂ and other non-condensable gases that separate from the condensate in the condenser 140 are compressed to gas generator (CG) 120 pressure and are preferably injected into the gas generator 120 cool down chambers. Such cool down chambers are sequential chambers progressively further from the injector face where the fuel inlet 122 and oxygen inlet 124 are located, with the water inlets 126 at or near the injector face and downstream non-condensable gas inlets 128 between sections thereafter to further cool the drive gas.

When low Btu fuels are used, such as BFG, the combustion temperature of the gas is in the 3,000° F. range, rather than 6,000° F. for high Btu fuels, and as a result, CO₂/N₂ and any other non-condensable gases (NCG) can be passed from the NCG outlet 144 of the condenser 140 to the NCG recirculation path 160 leading to the gas generator 120, and used as the diluent for the injector face as well as for the downstream combustion chamber walls. The remaining CO₂/N₂, about 60% of the total not used for cooling, is discharged from the excess NCG outlet 148 of the condenser 140 and is compressed at compressor 194 to high pressure (e.g. 1,400 to 1,800 psia) and delivered for CO₂ separation 190.

The advantage of cooling the combustion chamber walls or injector face with the inert gases results from the more efficient heat extraction that occurs when the ratio of sensible heat to latent heat increases in the turbine exhaust gases. The turbine exhaust gas sensible heat increases dramatically and the latent heat reduced proportionately when less water and more inert gases are recirculating in the cycle. This is clearly illustrated when conventional gas turbine combined cycles use air for the upper cycle and steam for the lower cycle. When the turbine exhaust has a high sensible to latent heat ratio, the heat recovery steam generator (HRSG) 210 can exchange more heat, more efficiently, to the pure steam bottoming cycle and thus reduces the heat rejected to the condenser 140 cooling water. The bottoming cycle includes the HRSG 210, the low pressure steam turbine 212, the steam condenser 214 and a pump 216. These effects increase the overall power plant 110 combined cycle efficiency.

Also, in order to reduce the high energy penalty of separating CO₂ gas from the nitrogen gas at the separator 190 for sequestration 200, a stream of cool nitrogen is extracted from the ASU 100 for cooling the CO₂/N₂ gas mixture that has been compressed (e.g. to 1,800 psia). A pressure above the critical pressure of CO₂ (1,070 psia), that includes the partial pressure affects of gas mixtures (Dalton's Law). The critical temperature of CO₂ remains at 88° F. This mixture of CO₂ and N₂ is then cooled to the triple point temperature of −69.88° F., preferably at least partially by utilization of an intercooler 192. At this temperature the vapor pressure of CO₂ decreases to 73.95 psia, or 6.91% of the critical pressure (1,070 psia) and where separation of the high pressure N₂ gas can occur with minimum CO₂ entrainment, by simply venting.

The vented high pressure gaseous N₂ remains at 1,800 psia and −70° F. and then heated in a heat exchanger 180 located at the gas generator (GG) 120 exhaust to 1,200° F. The hot N₂ is then expanded in a separate nitrogen turbine 182 from 1,700 psia to 14.7 psia and discharged to the atmosphere while generating supplementary power with a second generator. The remaining 95% CO₂ liquid plus 5% N₂ gas at 1,700 psia is at a suitable pressure for transport and injection into a sequestration site 200, or for other applications, such as enhanced oil recovery (EOR) or enhanced coal bed methane recovery (ECBM).

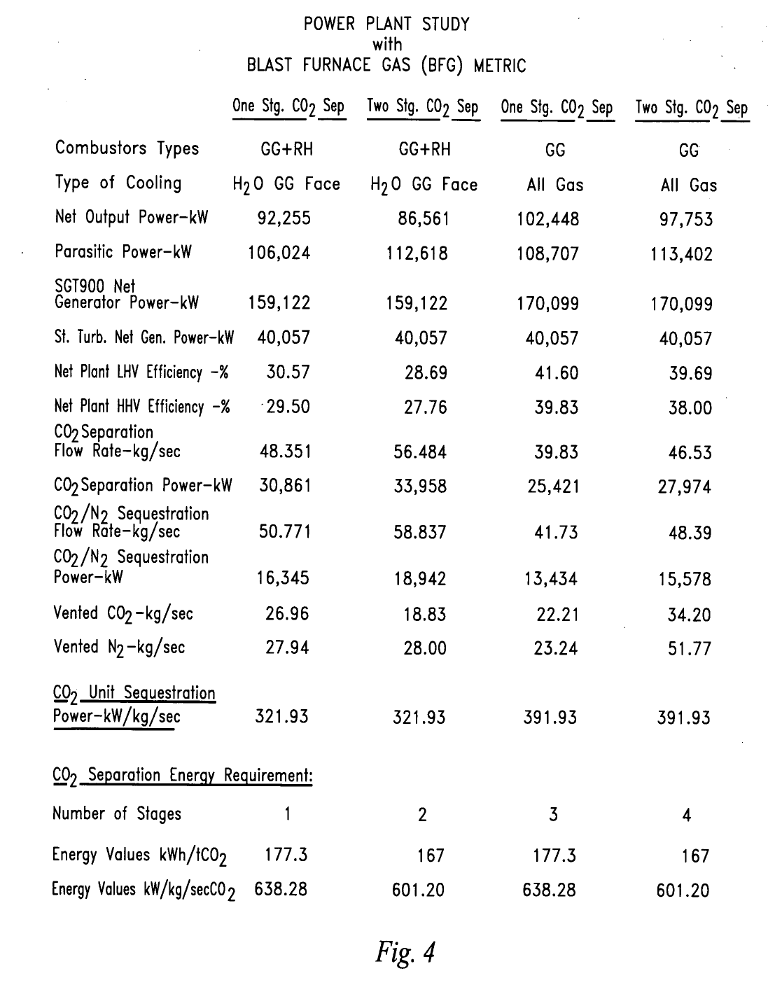

A reheater 170 is optionally provided to enhance thermal efficiency by reheating the drive gas before entering the gas turbine 130. FIG. 4 shows a table of parameters for variations of the system of FIG. 4. In the first two columns systems that include a reheater 170 are defined, with one or two stages of CO₂ separation in the separator 190. In the second two columns, systems without the reheater 170 are depicted.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted. When elements are described as upstream or downstream relative to other elements, such positioning can be with flow conduits therebetween and/or with other elements therebetween, or can be directly adjacent each other.

What is claimed is:

1. A method for low emissions combustion of low heating value fuel, including the steps of:
identifying a gas turbine having an air inlet, an air compressor downstream from the air inlet, a fuel inlet, a combustor downstream from the fuel inlet and the air compressor, a turbine downstream of the combustor and power output coupled to the turbine;
routing an oxidizer to the combustor via the fuel inlet, the oxidizer containing oxygen in an amount greater than an amount of oxygen present in air;
routing low heating value fuel to the combustor via the air inlet of the compressor, the low heating value fuel having a heating value less than natural gas;
combusting the low heating value fuel with the oxidizer to produce a drive gas including steam and carbon dioxide; and
driving the turbine with the drive gas of steam and carbon dioxide produced by said combusting step.

2. The method of claim 1 including the further step of condensing the steam in the steam and carbon dioxide drive gas downstream from the turbine after said driving step, said condensing step resulting in separation of at least a portion of water from the steam and carbon dioxide drive gas and a portion of carbon dioxide from the steam and carbon dioxide drive gas.

3. The method of claim 2 including the further step of sequestering carbon dioxide separated from the steam and carbon dioxide drive gas in said condensing step at a location spaced from a surrounding atmosphere.

4. The method of claim 2 including the further step of recirculating at least a portion of CO₂ separated from the steam and CO₂ drive gas during said condensing step back to the air inlet of the air compressor as a diluent gas for mixture with the low heating value fuel of said routing low heating value fuel step.

5. The method of claim 4 wherein said recirculating step includes providing the diluent gas with both carbon dioxide and nitrogen, the nitrogen at least partially contained within the low heating value fuel of said routing step and included with the drive gas produced by said combusting step.

6. The method of claim 5 including the further step of identifying an excess portion of the diluent gas including carbon dioxide and nitrogen, routing excess diluent gas including carbon dioxide and nitrogen to a carbon dioxide and nitrogen separator; and
sequestering carbon dioxide discharged from the carbon dioxide and nitrogen separator to a sequestration site isolated from the atmosphere.

7. The method of claim 2 including the further step of heating a separate working fluid within a heat recovery steam generator (HRSG) driven by excess heat from the drive gas of steam and carbon dioxide downstream of the turbine after said driving step and upstream of a condenser of said condensing step, said working fluid coupled to a turbine and adapted to drive the turbine after heating of the working fluid by the heat recovery steam generator, the turbine associated with the working fluid adapted to output additional power.

8. The method of claim 2 including the further step of returning water from the steam and CO₂ drive gas produced by said combusting step routed back to said combustor of said gas turbine.

9. The method of claim 8 wherein said returning step includes recirculating diluent gas back to said air inlet of said combustor for combination with said low heating value fuel, the diluent gas including steam.

10. The method of claim 9 wherein said diluent gas of said recirculating step includes a combination of both carbon dioxide and steam.

11. A system for low emissions power generation by combustion of a low heating value fuel having a heating value less than a heating value of natural gas, the system comprising in combination:
a gas compressor having a gas inlet, a combustor having an oxygen inlet coupled to a source of oxygen and coupled to said gas compressor downstream of said gas compressor;
a source of gaseous fuel having a low heating value than the heating value of natural gas, the source of low heating value fuel coupled to said gas inlet upstream of said gas compressor;
a combustor adapted to combust compressed low heating value fuel from the gas compressor with oxygen from the oxygen inlet to produce a drive gas including steam and carbon dioxide;
a gas turbine located downstream of said combustor, said gas turbine adapted to be driven by said drive gas including steam and carbon dioxide; and
said gas compressor driven by a drive shaft coupled to said turbine.

12. The system of claim 11 wherein a recirculation line is provided downstream of said gas turbine and upstream of said combustor, said recirculation line adapted to recirculate at least a portion of the drive gases produced within said combustor at a recirculating temperature less than a temperature of the drive gases when leaving the combustor, such that the recirculating drive gases reduce a temperature of the drive gases produced within said combustor and increase a mass flow rate of the drive gas.

13. The system of claim 12 wherein said recirculating line recirculates at least a portion of the drive gases to said combustor through said gas compressor for mixture of the recirculating drive gases with the low heating value fuel upstream of said combustor.

14. The system of claim 12 wherein said recirculation line is adapted to route recirculating drive gases back to said combustor through said oxygen inlet for combination of the recirculating drive gases with oxygen from the source of oxygen before entering said combustor.

15. The system of claim 12 wherein a condenser is interposed upstream of said recirculating line and downstream from said turbine, said condenser condensing at least a portion of water within the drive gas from carbon dioxide within the drive gas; and
said recirculating line adapted to recirculate a portion of the drive gas back to the combustor with the recirculated drive gas portion having a greater proportion of one of the constituents of the drive gas than was present upon discharge of the drive gas from the turbine.

16. The system of claim 15 wherein said recirculated drive gas includes more carbon dioxide than is present in said drive gas discharged from said turbine.

17. The system of claim 15 wherein said recirculated drive gas includes more water than is present in said drive gas discharged from said turbine.

18. The system of claim 12 wherein said low heating value fuel includes nitrogen, such that the drive gas driving said turbine includes nitrogen, said recirculation line adapted to route at least a portion of the nitrogen in the drive gas back to the gas inlet of the gas compressor.

19. The system of claim 12 wherein a condenser is located downstream of the turbine, the condense adapted to condense and separate at least a portion of water from the drive gas, said condenser including a non-condensed gas outlet coupled to said recirculation line for returning CO₂ and nitrogen to the gas inlet as a diluent gas to be compressed along with the fuel by the gas compressor.

20. The system of claim 11 wherein a heat recovery steam generator is located downstream of the turbine, the heat recovery steam generator adapted to transfer heat from the drive gas discharged from the turbine to a separate working fluid for separate beneficial use.

21. A closed Rankine cycle system for low emissions power generation with high contaminant fuels, comprising in combination:
a gas generator having an oxidizer inlet, a fuel inlet, a diluent inlet and a drive gas outlet;
said oxidizer inlet coupled to a source of oxygen having a greater proportion of oxygen than a proportion of oxygen in air;
said fuel inlet coupled to a source of fuel including hydrogen and/or carbon, an at least one contaminant that forms a contaminant gas when the fuel combusts with the oxidizer within the gas generator;
said gas generator adapted to combust the oxidizer with the fuel to produce a drive gas including steam and at least one contaminant gas;
an expander downstream of said drive gas outlet of said gas generator, said expander including a drive gas output;
said expander adapted to output power and reduce a pressure and temperature of the drive gas; and
a recirculation line adapted to recirculate at least a portion of the drive gas to the gas generator, including recirculation of at least a portion of the contaminant gas back to the gas generator.

22. The system of claim 21 wherein a condenser is provided downstream of said expander drive gas output, said condenser adapted to condense steam in the drive gas into liquid water, said condenser having an outlet for liquid water at least partially separated from non-condensable gases within said drive gas.

23. The system of claim 22 wherein said source of fuel includes a source of hydrocarbon fuel, such that said drive gas includes carbon dioxide as well as at least one contaminant gas, said condenser including a non-condensable gas outlet for CO₂ and contaminant gas, said non-condensable gas outlet coupled to a non-condensable gas recirculation line and a liquid water recirculation line extending from said liquid water outlet of said condenser to said gas generator, said non-condensable gas outlet recirculation line and said liquid water recirculation line separate from each other and each routed from said condenser to said gas generator.

24. The system of claim 23 wherein said liquid water recirculation line is coupled to said gas generator closer to said fuel inlet and said oxidizer inlet of said gas generator than where said non-condensable gas recirculation line is coupled to said gas generator.

25. The system of claim 22 wherein said source of fuel includes a source of fuel including nitrogen therein, with said nitrogen in said fuel producing nitrogen gas as a portion of said drive gas within said gas generator.

26. The system of claim 25 wherein said condenser includes said liquid water outlet separate from said non-condensable gas outlet, said liquid water outlet coupled to an excess water discharge from said system, said non-condensable gas outlet coupled to a non-condensable gas collection line separate from said non-condensable gas recirculation line in addition to said non-condensable gas recirculation line for removal of non-condensable gases from the primary closed loop Rankine cycle provided by said gas generator, said expander and said condenser.

27. The system of claim 25 wherein a carbon dioxide and nitrogen separator is provided downstream of said non-condensable gas excess line, said separator adapted to separate at least a portion of nitrogen from the carbon dioxide, said separator including an outlet for a flow of primarily carbon dioxide, said outlet upstream of a carbon dioxide sequestration site adapted to sequester carbon dioxide away from the atmosphere.

28. The system of claim 21 wherein a reheater is located downstream of said gas generator, said reheater adapted to increase a heat of the drive gas upstream of said expander, said reheater including an oxidizer inlet and a fuel inlet adapted to route a similar oxidizer and fuel as that combusted within said gas generator into said reheater.

29. The system of claim 28 wherein a heat exchanger is located between said gas generator and said reheater, said heat exchanger adapted to remove heat from the drive gas and add heat to a nitrogen line, said nitrogen line adapted to be fed with nitrogen at least partially from nitrogen separated from the drive gas as a contaminant within the drive gas, the nitrogen heated by said heat exchanger routed to a nitrogen turbine adapted to expand the nitrogen and output power.

30. The system of claim 22 wherein a heat recovery steam generator is interposed downstream of said turbine and upstream of said condenser, said heat recovery steam generator adapted to transfer heat from the drive gas to steam in a separate steam bottoming cycle including a steam turbine and steam condenser and pump, said steam turbine adapted to output power.
